(19) United States
(12) Patent Application Publication
(10) Pub. No.: US 2008/0309941 A1
(43) Pub. Date: Dec. 18, 2008

(54) Method of, System for, and Medical Image Acquisition System for Imaging an Interior of a Turbid Medium Taking Into Account the Geometry of the Turbid Medium

(75) Inventors: Martinus Bernardus Van Der Mark, Eindhoven (NL); Michael Cornelis Van Beek, Eindhoven (NL); Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,802

(22) PCT Filed: Nov. 20, 2006
(86) PCT No.: PCT/IB2006/054341

§ 371 Date: May 23, 2008

(30) Foreign Application Priority Data
Nov. 23, 2005 (EP) 05111165.6

(51) Int. Cl. G01N 21/00

(52) U.S. Cl. 356/435

(57) ABSTRACT

The invention relates to a method of imaging an interior of a turbid medium (45) comprising the following steps: accommodation of the turbid medium (45) inside a receiving volume; coupling transmission input light (65) from a transmission light source into the receiving volume, with said transmission input light (65) being chosen such that it is capable of propagating through the turbid medium (45); detection of transmission output light emanating from the receiving volume as a result of coupling transmission input light from the light source into the receiving volume through use of a transmission photodetector unit. The invention also relates to a system for imaging an interior of a turbid medium (45) and to a medical image acquisition system both using the method. The method, system, and medical image acquisition system are adapted such that an improved way of obtaining data relating to the exterior of the turbid medium (45) is realized. The object of the invention is realized in that the method further comprises the following steps:—coupling geometry input light (70, 75, 80) from a geometry light source into the receiving volume, with the receiving volume comprising the turbid medium (45) and with the combination of the geometry input light (70, 75, 80) and the interface (60) being chosen for creating a contrast between the turbid medium (45) and its surroundings; detection of the contrast (60) between the turbid medium (45) and its surroundings through use of a contrast photodetector unit; reconstructing an image of an interior of the turbid medium (45) using a the detected contrast (60). The system for imaging an interior of a turbid medium (45) and the medical image acquisition device are adapted to further comprise a geometry light source and a contrast photodetector unit.

### FIELD OF INVENTION

The invention relates to a method of imaging an interior of a turbid medium, said method comprising the following steps:

accommodation of the turbid medium inside a receiving volume;

coupling transmission input light from a transmission light source into the receiving volume, with said transmission input light being chosen such that it is capable of propagating through the turbid medium;

detection of transmission output light emanating from the receiving volume as a result of coupling transmission input light from the light source into the receiving volume through use of a transmission photodetector unit.

The invention also relates to a system for imaging an interior of a turbid medium comprising:

a receiving volume for accommodating the turbid medium;

a transmission light source for generating transmission input light to be coupled into the receiving volume, said transmission input light being chosen such that it is capable of propagating through the turbid medium.

The invention also relates to a medical image acquisition system comprising:

a receiving volume for accommodating the turbid medium;

a transmission light source for generating transmission input light to be coupled into the receiving volume, said transmission input light being chosen such that it is capable of propagating through the turbid medium.

### BACKGROUND OF THE INVENTION

An embodiment of a method, system, and medical image acquisition system of this kind is known from U.S. Pat. No. 6,130,958. The known method and systems can be used for imaging an interior of a turbid medium, such as biological tissues, using diffuse optical tomography. In medical diagnostics the method and systems may be used for imaging an interior of a female breast. A turbid medium, such as a breast, is accommodated inside a receiving volume. Transmission input light from a transmission light source impinges the turbid medium, with the transmission input light being chosen such that it is capable of propagating through the turbid medium. In diffuse optical tomography transmission input light having a wavelength within the range of 400 nm to 1400 nm is typically used. Transmission output light emanating from the turbid medium is detected. At the position where the transmission input light impinges the turbid medium, a bright spot is produced. This spot is detected using a sensor array. The output signal of the sensor array is in direct relationship to the perimeter of the scan turbid medium. The perimeter data and the data from the detected transmission output light are used together to reconstruct an image of the turbid medium.

### SUMMARY OF THE INVENTION

It is an object of the invention to provide an improved method of obtaining data relating to the external shape of the turbid medium under investigation. According to the invention this object is realized in that the method further comprises the following additional steps:

coupling geometry input light from a geometry light source into the receiving volume, with the receiving volume comprising the turbid medium and with the combination of the geometry input light and the interface being chosen for creating a contrast between the turbid medium and its surroundings;

detection of the contrast between the turbid medium and its surroundings through use of a contrast photodetector unit;

reconstructing an image of an interior of the turbid medium using a the detected contrast.

The invention is based on the recognition that the combination of light that is coupled into receiving volume and the interface between the turbid medium and its surroundings in the receiving volume when light is coupled into the receiving volume allows to create or enhance a contrast between the turbid medium and its surroundings.

An embodiment of the method according to the invention is characterized in that the geometry input light has a wavelength outside the wavelength range of the transmission input light. This embodiment has the advantage that it is easy to implement. Only a light source capable of generating geometry input light having a wavelength outside the wavelength range of the transmission input light is needed together with a detector unit capable of detecting geometry output light emanating from the receiving volume as a result of coupling geometry input light into the receiving volume.

A further embodiment of the method according to the invention is characterized in that the method further comprises a step of enhancing the contrast between the turbid medium and its surroundings by accommodating a contrast enhancer at least at the interface between the turbid medium and its surroundings. This embodiment has the advantage that the contrast between the turbid medium and its surroundings can be further enhanced by the use of a contrast enhancer that indicates the external shape of at least a part of the turbid medium.

A further embodiment of the method according to the invention is characterized in that the contrast enhancer is chosen for at least partially reflecting geometry input light. This embodiment has the advantage that by covering a surface of the turbid medium with a contrast enhancer that at least partially reflects geometry input light, the contrast between the surface of the turbid medium and its surroundings at the wavelength of the geometry input light is enhanced. The exterior of the turbid medium becomes better visible at the wavelength of the geometry input light.

A further embodiment of the method according to the invention is characterized in that the contrast enhancer is chosen for at least partially absorbing geometry input light. This embodiment has the advantage that it provides an alternative way, compared to the previous embodiment, of enhancing the contrast between the turbid medium and its surroundings. Instead of improving the visibility of the exterior of the turbid medium and the wavelength of the geometry input light, the contrast between the contour of the turbid medium and its surroundings is enhanced.

A further embodiment of the method according to the invention is characterized in that the contrast enhancer is chosen for emitting fluorescence light in response to at least a part of the geometry input light. This embodiment has the advantage that accommodating a contrast enhancer and the interface between the turbid medium and its surroundings, with the contrast enhancer comprising a fluorescent agent enables direct imaging of the external shape of the surface at the wavelength of the fluorescence light emitted by the fluorescent agent.

A further embodiment of the method according to the invention is characterized in that the contrast enhancer extends away from the turbid medium. This embodiment has the advantage that it provides an alternative way, compared to the previous embodiment, of using a fluorescent agent to enhance the contrast between the turbid medium and its surroundings. Instead of using fluorescence to obtain a positive image of the exterior shape of the turbid medium this embodiment allows to obtain data relating to the exterior shape of the turbid medium by surrounding the turbid medium by a region comprising a fluorescent agent that is excited by the geometry input light whereas the turbid medium comprises no such fluorescent agent.

The object of the invention is further realized with a system for imaging an interior of a turbid medium comprising:

a receiving volume for accommodating the turbid medium;

a transmission light source for generating transmission input light to be coupled into the receiving volume, said transmission input light being chosen such that it is capable of propagating through the turbid medium;

characterized in that

the system further comprises:

a geometry light source for generating geometry input light to be coupled into the receiving volume;

a photodetector unit for detecting the contrast between the turbid medium and its surroundings by detecting output geometry light emanating from the receiving volume as a result of coupling geometry input light into the receiving volume;

an image reconstruction unit for deriving an image of an interior of the turbid medium using detected transmission output light and the detected contrast,

for carrying out the method according to any one of the previous embodiments.

A system for imaging an interior of a turbid medium would benefit from any of the previous embodiment of the method according to the invention.

An embodiment of the system for imaging an interior of a turbid medium according to the invention is characterized in that the system for imaging an interior of a turbid medium further comprises a contrast enhancer for enhancing the contrast between the turbid medium and its surroundings. This embodiment has the advantage that the interface between the turbid medium and its surroundings, and hence the exterior shape of the turbid medium, can be distinguished better if the contrast between the turbid medium and its surroundings is enhanced.

A further embodiment of the system for imaging an interior of a turbid medium according to the invention is characterized in that the transmission photodetector unit and the contrast photodetector unit are comprised in a single photodetector unit. This embodiment has the advantage that there is no need for a separate transmission photodetector and contrast photodetector units.

The object of the invention is further realized with a medical image acquisition system comprising:

a receiving volume for accommodating the turbid medium;

a transmission light source for generating transmission input light to be coupled into the receiving volume, said transmission input light being chosen such that it is capable of propagating through the turbid medium;

characterized in that

the medical image acquisition system further comprises:

a geometry light source for generating geometry input light to be coupled into the receiving volume;

a photodetector unit for detecting the contrast between the turbid medium and its surroundings by detecting output geometry light emanating from the receiving volume as a result of coupling geometry input light into the receiving volume;

an image reconstruction unit for deriving an image of an interior of the turbid medium using detected transmission output light and the detected contrast,

for carrying out the method according to any one of the previous embodiments.

A medical image acquisition system would benefit from any of the previous embodiment of the method according to the invention.

An embodiment of the medical image acquisition system according to the invention is characterized in that the medical image acquisition system further comprises a contrast enhancer for enhancing the contrast between the turbid medium and its surroundings. This embodiment has the advantage that the interface between the turbid medium and its surroundings, and hence the exterior shape of the turbid medium, can be distinguished better if the contrast between the turbid medium and its surroundings is enhanced.

A further embodiment of the medical image acquisition system according to the invention is characterized in that the transmission photodetector unit and the contrast photodetector unit are comprised in a single photodetector unit. This embodiment has the advantage that there is no need for a separate transmission photodetector and contrast photodetector units.

### BRIEF DESCRIPTION OF THE DRAWINGS

These and other aspects of the invention will be further elucidated and described with reference to the drawings, in which:

FIG. 1 shows an embodiment of the method according to the invention.

FIG. 2 shows a device for performing measurements on a turbid medium is known from the prior art.

FIG. 3 shows an embodiment of a turbid medium, the surface of which is partially covered by a contrast enhancer.

FIG. 4 shows an embodiment of a medical image acquisition device according to the invention.

### DETAILED DESCRIPTION OF THE EMBODIMENTS

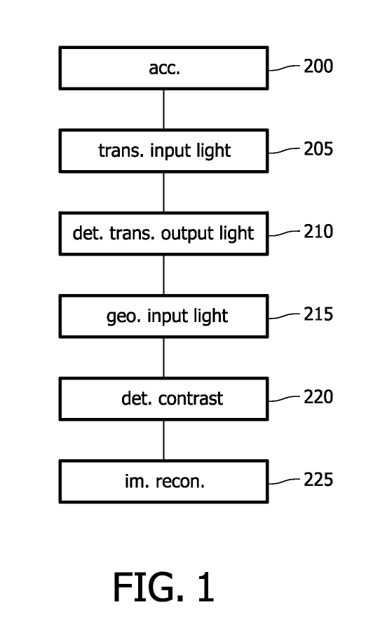

FIG. 1 shows an embodiment of the method according to the invention. In step 200 a turbid medium is accommodated inside a receiving volume. Next, in step 205, transmission input light generated by a transmission light source is coupled into the receiving volume, with the transmission input light being chosen such that it is capable of propagating through the turbid medium. In one medical application of the method, one in which the method is used for imaging an interior of a female breast, the transmission input light typically has a wavelength within the range of 400 nm to 1400 nm. At least a part of the transmission input light passes through the turbid medium. Transmission output light emanating from the receiving volume as a result of coupling transmission input light into the receiving volume is detected in step 210 through use of a transmission photodetector unit.

According to the invention, geometry input light from a geometry light source is coupled into the receiving volume, with the receiving volume comprising the turbid medium and with the combination of the geometry input light and the interface being chosen for creating a contrast between the turbid medium and its surroundings. This is done in step 215. A number of combinations is especially advantageous, as will be discussed below. Next, in step 220 the contrast created between the turbid medium and its surroundings is detected. In step 225 the detected contrast is used in reconstructing an image of an interior of the turbid medium. In this step the transmission output light detected in step 210 is used as well.

As mentioned, a number of combinations of the geometry input light and the interface between the turbid medium and its surroundings is especially advantageous for creating the contrast between the turbid medium and its surroundings. This will now be further elucidated.

A first especially advantageous combination is one in which the geometry input light has a wavelength outside the wavelength range of the transmission input light. For imaging an interior of the turbid medium the transmission input light is specifically chosen such that it is capable of propagating through the turbid medium. In one medical application of the known method, the imaging of an interior of a female breast, transmission input light with a wavelength within the range of 400 nm to 1400 nm is typically used. Light having a wavelength outside this wavelength range does not penetrate deep into human skin. Hence, such light can be used to obtain data relating to the exterior of the turbid medium. For obtaining data relating to the exterior of a female breast light within the green or blue range of the electromagnetic spectrum is an example of suitable light.

A second especially advantageous combination is one that further comprises a step of enhancing the contrast between the turbid medium and its surroundings by accommodating a contrast enhancer at least at the interface between the turbid medium and its surrounding such that the contrast enhancer is indicative of the shape of the turbid medium at the interface. Enhancing the contrast makes the turbid medium better distinguishable from its surroundings.

A first advantageous enhancement method is to choose the contrast enhancer such that at least a part of the light arriving at the contrast enhancer is reflected. In this way, the visibility of the turbid medium at the wavelength of the geometry input light is improved. For the medical application of the method according to the invention in which an interior of a female breast is imaged, an example of a suitable contrast enhancer is blue body paint.

A second advantageous enhancement method is to choose the contrast enhancer such that at least a part of the geometry input light is absorbed. In this way, the turbid medium becomes darker at the wavelength of the light reaching the contrast enhancer, for instance, the geometry input light. Hence, the contrast between the turbid medium and its surroundings is enhanced. For the medical application of the method according to the invention in which an interior of a female breast is imaged, an example of a suitable contrast enhancer is a body paint containing the dye known as brilliant black.

A third advantageous enhancement method is to choose the contrast enhancer of such that it emits fluorescence light in response to at least a part of the geometry input light. In this way, the contour of the turbid medium becomes fluorescent as a result of which the external shape of the turbid medium becomes visible at the wavelength of the fluorescence light emitted by the contrast enhancer. Moreover, whereas light that is reflected at or near the surface of the turbid medium passes through the measurement volume twice, once prior to and once after reflection, the fluorescent light only passes through the measurement volume once as it goes from the turbid medium to a detection position. This makes image reconstruction easier. This option is especially advantageous if the light exciting the fluorescent agent comprised in the contrast enhancer and the transmission input light are the same. Then, an interior of the turbid medium and the exterior of the turbid medium can be probed in a single measurement with a part of the light exciting the contrast enhancer and another part of the light passing through the turbid medium. For the medical application of the method according to the invention in which an interior of a female breast is imaged, an example of a suitable contrast enhancer is a body paint containing Alexa Fluor 430 or dyes with spectrums similar to that of Alexei Fluor 430. An alternative use of a fluorescent agent to enhance a contrast between the turbid medium and its surroundings is to surround the turbid medium by a region comprising a fluorescent agent that extends away from the turbid medium. In this way to regions are created inside the receiving volume, one which comprises a fluorescent agent that can be excited by the geometry input light and one, being the turbid medium itself, that does not comprise such a fluorescent agent. This use of a fluorescent agent allows to obtain a negative image of the turbid medium. Excitation of a fluorescent agent may be achieved by geometry input light having a wavelength within the normal wavelength range of the transmission input light or by geometry input light having a wavelength outside the wavelength range of the transmission input light. If the transmission input light and the geometry input light are the same, that is if the geometry input light has a wavelength within the normal wavelength range of the transmission input light, then there is no need for a separate transmission light source and geometry light source.

Clearly, the sequence of steps shown in FIG. 1 is not the only possible sequence. In FIG. 1 obtaining data relating to the exterior of the turbid medium is preceded by obtaining data relating to an interior of the turbid medium. This order may be reversed. Moreover, it will be clear from the description given above that the steps of obtaining data relating to an interior of the turbid medium end of obtaining data relating to the exterior of the turbid medium may also be combined.

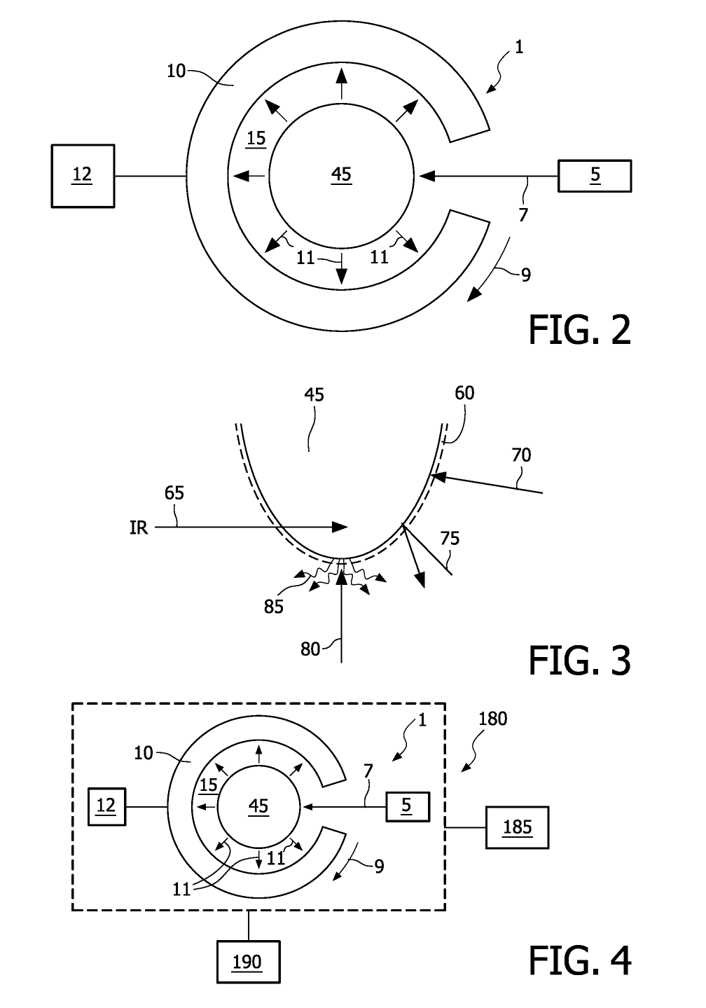

FIG. 2 shows a device for performing measurements on a turbid medium is known from the prior art. The device 1 includes a transmission light source 5, a transmission photodetector array 10, an image reconstruction unit 12, and a receiving volume 15. A turbid medium 45 is placed inside the receiving volume 15. The turbid medium 45 is then irradiated with transmission input light from the light source 5, as schematically indicated by the light ray 7, from a plurality of positions by rotating and translating the light source 5 and the transmission photodetector array 10 relative to the turbid medium 45. Rotation is schematically indicated by the arrow 9. The transmission input light is chosen such that it is capable of propagating through the turbid medium 45. Transmission output light (schematically indicated by the arrows 11) emanating from the receiving volume 15 as a result of irradiating the turbid medium 45 with transmission input light is detected from a plurality of positions through use of transmission photodetector array 10. The detected transmission output light is then used to reconstruct an image of an interior of the turbid medium 45. Reconstruction of an image of an interior of the turbid medium 45 based on the detected transmission output light is possible as at least part of this light has traveled through the turbid medium 45 and, as a consequence, contains information relating to an interior of the turbid medium 45.

FIG. 3 shows an embodiment of a turbid medium, the surface of which is partially covered by a contrast enhancer. The contrast enhancer 60 may, for example, be a cream or latex. Transmission input light ray 65 passes through the contrast enhancer 60 and enters the turbid medium 45 in order to be scattered and detected. The contrast enhancer 60 is substantially opaque to geometry input light rays 70, 75, and 80. Light rays 70, 75, and 80 may, for example, have wavelengths in the blue or green range of the electromagnetic spectrum. Light ray 70 is absorbed by the contrast enhancer 60. Light ray 75 is reflected by the contrast enhancer 60. Light ray 80 causes fluorescent emission 85 in the contrast enhancer 60. As an alternative, a contrast enhancer 60 comprising a fluorescent agent may extend away from the turbid medium 45 into the region surrounding the turbid medium 45. In this way, two regions are created, one region that comprises a fluorescent agent that can be excited by the geometry input light and a region, being the turbid medium itself, that does not comprise such a fluorescent agent. A region comprising a fluorescent agent may be created by accommodating the turbid medium 45 in a fluid comprising a fluorescent agent that can be excited by the geometry input light.

FIG. 4 shows an embodiment of a medical image acquisition device according to the invention. The medical image acquisition device 180 comprises the device 1 discussed in FIG. 2 as indicated by the dashed square. In addition to the device 1 the medical image acquisition device 180 further comprises a screen 185 for displaying an image of an interior of the turbid medium 45 and an input interface 190, for instance, a keyboard enabling and operated to interact with the medical image acquisition device 180.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. A method of imaging an interior of a turbid medium, said method comprising the following steps:
accommodation of the turbid medium inside a receiving volume;
coupling transmission input light from a transmission light source into the receiving volume, with said transmission input light being chosen such that it is capable of propagating through the turbid medium;
detection of transmission output light emanating from the receiving volume as a result of coupling transmission input light from the light source into the receiving volume through use of a transmission photodetector unit,
characterized in that
the method further comprises the following additional steps:
coupling geometry input light from a geometry light source into the receiving volume, with the receiving volume comprising the turbid medium and with the combination of the geometry input light and the interface being chosen for creating a contrast between the turbid medium and its surroundings;
detection of the contrast between the turbid medium and its surroundings through use of a contrast photodetector unit;
reconstruction of an image of an interior of the turbid medium using a the detected contrast.

2. A method as claimed in claim 1, wherein the geometry input light has a wavelength outside the wavelength range of the transmission input light.

3. A method as claimed in claim 1, further comprising a step of enhancing the contrast between the turbid medium and its surroundings by accommodating a contrast enhancer at least at the interface between the turbid medium and its surroundings.

4. A method as claimed in claim 3, wherein the contrast enhancer is chosen for at least partially reflecting geometry input light.

5. A method as claimed in claim 3, wherein the contrast enhancer is chosen for at least partially absorbing geometry input light.

6. A method as claimed in claim 3, wherein the contrast enhancer is chosen for emitting fluorescence light in response to at least a part of the geometry input light.

7. A method as claimed in claim 6, wherein the contrast enhancer extends away from the turbid medium.

8. A system for imaging an interior of a turbid medium comprising:
a receiving volume for accommodating the turbid medium;
a transmission light source for generating transmission input light to be coupled into the receiving volume, said transmission input light being chosen such that it is capable of propagating through the turbid medium;
a transmission photodetector unit for detecting transmission output light emanating from the receiving volume as result of coupling transmission input light from the transmission light source into the receiving volume,
characterized in that
the system further comprises:
a geometry light source for generating geometry input light to be coupled into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,
for carrying out the method according to claim 1.

9. A system for imaging an interior of a turbid medium as claimed in claim 8, wherein the system for imaging interior of the turbid medium further comprises a contrast enhancer for enhancing the contrast between the turbid medium and its surroundings.

10. A system for imaging an interior of a turbid medium as claimed in claim 8, wherein the transmission photodetector unit and the contrast photodetector unit are comprised in a single photodetector unit.

11. A medical image acquisition system comprising:
a receiving volume for accommodating the turbid medium;
a transmission light source for generating transmission input light to be coupled into the receiving volume, said transmission input light being chosen such that it is capable of propagating through the turbid medium;
a transmission photodetector unit for detecting transmission output light emanating from the receiving volume as result of coupling transmission input light from the transmission light source into the receiving volume,
characterized in that
the medical image acquisition system further comprises:
a geometry light source for generating geometry input light to be coupled into the receiving volume;
a contrast photodetector unit for detecting the contrast between the turbid medium and its surroundings by detecting output geometry light emanating from the receiving volume as a result of coupling geometry input light into the receiving volume;
an image reconstruction unit for deriving an image of an interior of the turbid medium using detected transmission output light and the detected contrast,
for carrying out the method according to claim 1.

12. A medical image acquisition system as claimed in claim 11, wherein the medical image acquisition system further comprises a contrast enhancer for enhancing the contrast between the turbid medium and its surroundings.

13. A medical image acquisition system as claimed in claim 11, wherein the transmission photodetector unit and the contrast photodetector unit are comprised in a single photodetector unit.
